(19) United States
(12) Patent Application Publication
(10) Pub. No.: US 2007/0148321 A1
(43) Pub. Date: Jun. 28, 2007

(54) Mineral-containing acidic protein drink

(76) Inventors: Shigeru Ashida, Ibaraki (JP); Tsutomu Saito, Osaka (JP); Toshio Kiriyama, Osaka (JP); Masako Yoshida, Osaka (JP)

Correspondence Address: J C PATENTS, INC., 4 VENTURE, SUITE 250, IRVINE, CA, 92618, US

(21) Appl. No.: 10/598,604

(22) PCT Filed: Mar. 8, 2005
(86) PCT No.: PCT/JP05/03990

§ 371 Date: Sep. 5, 2006

(30) Foreign Application Priority Data
Mar. 8, 2004 (JP) 2004-064101
Oct. 15, 2004 (JP) 2004-302071

(51) Int. Cl. A23L 1/20

(52) U.S. Cl. 426/634

(57) ABSTRACT

It is intended to provide a food or a drink with a favorable flavor which has an acidic nature, contains protein and minerals, and has been stabilized in dispersion without showing any protein aggregation or the like even in the absence of a stabilizer. It is also intended to provide such an acidic protein food or drink which shows no protein aggregation even in the case of using not only minerals hardly soluble in aqueous media but also highly soluble minerals. By using an acid-soluble soybean protein, it is possible to provide an acidic mineral-containing food or drink which has a high stability without resort to a stabilizer as an essential component. Owing to the acidic nature, moreover, a product having a refreshing flavor, which is never achieved by neutral foods or drinks, can be prepared.

### BACKGROUND OF THE INVENTION

1. Field of Invention

This invention provides an acidic food or drink containing protein and minerals, with a good nutritive value but no aggregation.

2. Description of Related Art

In recent years, the concern on protein intake has increased not only from athletes but also from the elders and healthy persons. Among various proteins, the soybean protein is known for its nutritive and physiological effects, so that foods and drinks containing soybean protein as protein sources are desired in consumers' consideration for health. In these years, the consumption of soybean milk is significantly increased, demonstrating great expectation on soybean from the consumers. However, the traditional soybean processed food and drinks, such as bean curd, sandwiched bean curd and fried bean curd, are near neutral, and the variation in taste is prone to be little. Among the soybean milks, it is also the neutral one that is leading. Although there are some soybean milks with acidic taste, special techniques are required for producing them. It is considered that the variation in taste is much and the demand of the consumers is high if there are acidic soybean foods and drinks. Moreover, the physiological effects of mineral as a nutrient other than proteins are being revealed and get much attention. Specifically, the Japanese usually do not intake a required amount of calcium, and are advised to intake calcium actively.

In general, various problems as described below will take place when an acidic soybean protein food or drink is being manufactured. For example, when drinks containing soybean protein are being manufactured in an acidic zone, aggregation of the protein is induced as the pH value is adjusted near the isoelectric point of soybean protein. To disperse the aggregations and avoid precipitation, addition of a stabilizer or a physical treatment like a high-pressure homogenizer treatment is needed. However, precipitation will still take place and the taste will become very harsh over time, while addition of a large amount of stabilizer makes the taste bad. In a case where an acidic food or drink is manufactured with soybean milk or isolated soybean protein as a main material, the pH value is generally decreased with an acidulant, but protein aggregation easily occurs when the pH value passes the isoelectric point. Furthermore, when minerals are added for purposes like enhancing the nutrition, aggregation is induced more easily, thus the usable materials are limited to insoluble minerals to avoid aggregation. To address these problems, various discussions have been provided in the prior art.

According to Patent Document 1, a solution containing hydrated soybean protein is added with calcium and heated, and after the protein is solidified, mechanical homogenization is performed with a high-pressure homogenizer. Although the Patent also discloses a manufacturing process of an acidic protein drinks in which an acidulant is added to make a pH value below 4.5 for sufficient sterilization and then homogenization is performed again, the process is complicated, while such complicated treatments still cannot prevent precipitation. Additionally, a large amount of acidulant is needed for the buffer capacity of protein, resulting in overly strong sourness, so that the protein concentration in the drink has to be limited to approximately 6 wt % to avoid the problem. Moreover, in Patent Document 2, a manufacturing process of a calcium-enhanced concentrated acidic milk drink that includes a process of homogenizing an acidic milk containing pectin and a process of adding calcium and sugar. Although the aggregation and precipitation in the drink made from the process are less, the process is complicated and the taste of the drink is harsh due to the use of the stabilizer.

[Patent Document 1] Japan Patent Publication No. Hei 5-308900.

[Patent Document 2] Japan Patent Publication No. Hei 11-187851.

### SUMMARY OF THE INVENTION

### Issues to be Solved

To address the above problems, this invention provides a stable acidic food or drink, namely, an acidic food or drink with a pH value of 2-6 in which aggregation does not occur even in the presence of water-soluble minerals and precipitation is inhibited even after long-term conservation. Moreover, this invention provides a mineral-containing acidic protein food or drink with a good taste of moderate sourness but no harsh sense as being swallowed, which does not need a stabilizer or a homogenizing treatment using a high-pressure homogenizer or the like that is needed by general protein foods and drinks containing minerals.

### SOLUTIONS TO THE ISSUES

This invention relates to 1) an acidic food or drink containing acid-soluble soybean protein and minerals, 2) the above acidic food or drink in 1) with a pH value of 2-6, and 3) the above acidic food or drink in 1) wherein the minerals are water-soluble.

### EFFECTS OF THE INVENTION

According to this invention, an acidic protein food or drink containing minerals to have a high nutritive value and having a good taste can be provided. Moreover, it is not necessary to add a stabilizer or perform homogenization using a high-pressure homogenizer or the like, since protein aggregation will not take place even in the presence of water-soluble minerals. Additionally, a food or drink that is smooth as being swallowed and has a good taste can be obtained in the absence of a stabilizer. Moreover, precipitation due to long-term conservation, which is particularly a problem for drinks, can also be inhibited. Hence, the protein foods and drinks currently led by those of neutral taste like soybean milk can have a variety of tastes, thus enriching the foodlife.

It is to be understood that both the foregoing general description and the following detailed description are exemplary, and are intended to provide further explanation of the invention as claimed.

### DESCRIPTION OF EMBODIMENTS

As described above, there are difficulties and many problems in preparing a mineral-containing acidic food or drink from soybean protein or soybean milk.

On the other hand, the acidic protein food or drink of this invention is intended to address those problems by including acid-soluble soybean protein. In the case of this invention using acid-soluble soybean protein, a stable acidic food or drink can be prepared without adding a stabilizer. In addition, the stability can be maintained even when water-soluble minerals, not to mention water-insoluble minerals, are added.

Therefore, an acidic protein food or drink with enhanced mineral nutrient can be prepared. The embodiments of this invention will be described in details below.

The acidic food or drink of this invention (referred to as “the present food or drink”, hereinafter) features in containing acid-soluble soybean protein and minerals.

The acid-soluble soybean protein used in this invention may be an acid-soluble soybean protein with a dissolution percentage (defined later) of more than 55%, preferably more than 65% and more preferably more than 80% at a pH value of 2-4.3. The manufacturing process of such an acid-soluble soybean protein is not particularly limited, possibly being the one disclosed in WO2002/67690 or Japan Patent Publication No. Sho 53-19669.

Specifically, the process is characterized in including a treatment for increasing the positive charges on the surface of the soybean protein particles in an acidic zone and/or a heating treatment in an acidic zone to a solution containing soybean protein. Specifically, the process includes one or a combination of the following Treatments (A)-(C) in an acidic zone.

Treatment (A) is to remove or deactivate the polyanionic materials like phytic acid coming from the raw protein in the solution containing soybean protein, for example, to remove the phytic acid in the soybean with a phytase or the like.

Treatment (B) is to add a polycationic material like chitosan into the solution containing soybean protein.

Treatment (C) is a heating treatment to the solution containing soybean protein at a temperature above 100° C. in an acidic zone below the isoelectric point of the protein. With the treatment(s), the dissolution percentage of the soybean protein under an acidic condition is increased and aggregation is prevented under an acidic condition stabilizing the dispersion and also inhibiting precipitation during the conservation of the acidic food or drink.

The choice between the acid-soluble soybean proteins subjected to different treatments depends on the pH value and the form of the acidic food or drink. Treatment (C) alone only increases the dissolution percentage of the protein in relatively lower pH and even in the acidic zone of pH 2-3.5. Therefore, it is preferred to choose the soybean protein having been subjected to at least one of Treatments (A) and (B) to obtain a stabilized dispersion of the protein in a broader pH range.

In particular, it is more preferred to choose the soybean protein that is subjected to Treatment (C) after at least one of Treatments (A) and (B) when an acidic food or drink with high dissolution percentage in a broad pH range is desired to obtain. Thereby, an acid-soluble soybean protein can be obtained having a higher dissolution percentage and making a higher clarity under an acidic condition as well as causing little precipitation during the conservation of the acidic food or drink containing it.

In this invention, the soybean protein source as a raw material of the acid-soluble soybean protein is not particularly limited, if only it contains soybean protein. The soybean protein source may be suitably selected from soybean milk (whole or defatted, hereinafter), acid-precipitated curd of soybean milk, soybean protein isolate (SPI), soybean powder and ground soybean. Water can be added to the soybean protein source as required.

The amount of the acid-soluble soybean protein in the present food or drink is not particularly limited, and the optimal value may be determined by one skilled in the art according to the form, processing method, composition, and purpose of the food or drink. For example, in the cases of drinks, the taste and the swallow feel are good when the amount relative to the total solid content is 0.1-20 wt %, preferably 0.5-10 wt % and more preferably 1-5 wt %. Moreover, in the cases of gel foods such as jelly, the percentage is 1-25 wt %, preferably 3-12 wt %. The protein intake becomes meaningless if the amount is too small.

The minerals of this invention are salts as supply sources of minerals or those coming from food materials or the like, while there is no particular limitation to their species or sources if only they are edible. The representative salts are salts, hydroxides, oxides of alkaline-earth metals like calcium and magnesium and transition metals like iron and zinc, for example, organic and inorganic salts like calcium chloride, calcium gluconate, calcium lactate, calcium citrate, calcium hydroxide, calcium carbonate, calcium phosphate, calcium pantothenate, eggshell calcium, coral calcium, whey calcium, magnesium chloride, magnesium oxide, magnesium carbonate, dolomite, iron(III) chloride, iron citrate, iron lactate and iron(III) pyrophosphate, etc. Moreover, the food materials include green and yellow vegetable juices of the vegetables containing more alkaline earth metals like calcium and magnesium, especially spinage, pumpkin, rape, Brassica Chinensis L., Brassica campestris, molokheiya and broccoli. As the vegetable juices are used, enzymes like tannase, chlorogenase, carboxyl esterase, pectin esterase, cholesterol esterase, lipoprotein lipase, pectinase may be used to further enhance the dispersibility.

Among the above minerals, water-soluble minerals are preferred due to their good absorbability in the body and their dissolubility in foods and drinks that results in no harsh sense or the like. The solubilities of some calcium salts in 100 g of water at 25° C. are shown in Table 1 as the water-solubility indexes of the minerals in this invention. Taking the calcium minerals as an example, those with solubility above 10 mg, preferably above 100 mg and more preferably above 500 mg, are suitable. Specific examples of the water-soluble minerals include calcium lactate, calcium gluconate, calcium pantothenate, primary calcium phosphate, fermented calcium lactate and iron lactate, etc., wherein calcium lactate, calcium gluconate and iron lactate are preferred in consideration of the taste.

Additionally, ordinary soybean proteins are inherently insoluble under an acidic condition, while adding water-soluble minerals further facilitates the aggregation. Therefore, water-insoluble minerals are preferably used in the prior art, causing harsh sense in the foods and drinks. However, the present food or drink is not exclusive of containing water-insoluble minerals. Even when insoluble minerals are used, they can be subjected to micro-granulation or coated with an emulsifier to make precipitation hardly form, thus being particularly suitable in the applications of drinks.

TABLE 1

| | mg/100 g of water |
|---|---|
| calcium chloride | 59,500 |
| calcium acetate | 52,000 |
| L(+) calcium lactate | 9,600 |
| DL-calcium lactate | 6,500 |
| calcium gluconate | 3,500 |
| calcium primary phosphate | 1,830 |
| calcium malate | 920 |
| calcium hydroxide | 185 |
| calcium sulfate | 160 |
| calcium citrate | 85 |
| calcium secondary phosphate | 23 |
| Hydroxyapatite | 2.5 |
| calcium tertiary phosphate | 2.5 |
| calcium carbonate | 1.4 |
| calcium oxalate | 0.7 |

Although the stabilizer is not a necessary constituent in this invention, when it is desired to further inhibit the precipitation during the conservation in a pH range, it can also be used. Well-known stabilizers include water-soluble soybean polysaccharides, HM pectin, LM pectin, carboxymethyl cellulose and salts thereof, crystalline cellulose, propyleneglycol alginate, gellan gum, carrageenan, locust bean gum, gum arabic, gum tragacanth, furcellaran, karaya gum, xanthan gum, guar gum, tara gum, tamarind seed gum, glucomannan and galactomannan, etc.

The amounts of these minerals in the present food or drink can be adjusted according to the species, purposes and tastes, etc. of the same, each in a suitable intake range as required in nutrition. For example, in a case where an alkaline-earth metal like calcium or magnesium is used, the amount of alkaline earth metal ions per 100 g of food or drink containing acid-soluble soybean protein is more than 5 mg, preferably 10-600 mg, more preferably 50-400 mg and particularly preferably 100-250 mg. If the amount is less than 5 mg, the calcium amount is insufficient; if the amount is too much, a good taste is difficult to obtain.

The present acidic food or drink has a pH value in the acidic zone of pH=2-6, which can prevent protein aggregation and stabilize the dispersion of the protein. This is desirable in that precipitation during the conservation of the drink can be inhibited and that the eating feels like taste can be good for those foods with low fluidity. The more preferred range is the range of pH=2-5+The range of pH=2-4.3 is even more preferred as particularly preventing precipitation in the conservation of the drink. Inter alia, the range of pH-2.5-4.0 is preferred because of the suitable sourness and the refreshing taste. In the preparation of an acidic protein food or drink with conventional protein materials like soybean protein isolate or dairy products, since the conventional protein materials are generally neutral, a large amount of acidulant is needed for the acidity because of the high protein concentration. This results from the high buffer capacity of the protein, while the food or drink is difficult to be attractive due to the overly strong sourness. Therefore, the amount of the protein must be limited in the prior art. On the other hand, since the aqueous solution of the acid-soluble soybean protein used in this invention is acidic, the acidulant used to adjust the sourness is required less as compared with the cases using neutral protein. Accordingly, the sourness is ready to adjust, while a product with a higher protein content can be provided.

In addition to acid-soluble soybean protein and minerals, the present food or drink may contain acidic gustatory materials, sugars, greases, various vitamins, flavors, food fibers, polysaccharides, alcohols and colorants, etc.

The acidic gustatory materials include fruit juice, fruit flesh, vegetable juice, vegetable, yoghourt, fermented milk, sour cream and the flavor analogues thereof, and acidic materials like organic acids and inorganic acids, etc. Examples of the organic acids include citric acid, malic acid, lactic acid, tartaric acid, gluconic acid, acetic acid, etc., wherein the tastes of gluconic acid, citric acid, malic acid and lactic acid are preferred.

The species of the sugars are not particularly limited. In addition to sucrose, maltose, fructose, glucose, invert sugars, mixed liquid sugars, sugar syrups, dextrin materials, sugar alcohols, dextrin, oligosaccharides, monosaccharides and disaccharides, for example, high-sweetness sweeteners merely for giving sweetness like Aspartame and Stevia can also be used. Moreover, the honey used for drinks is generally desalted to remove minerals in the prior art. In this invention, however, honey can be directly used without subjecting to a desalting treatment.

The present food or drink also can be prepared with various greases, provided a stable emulsion can be achieved, while the species of the greases are not particularly limited if only they are edible. The examples include vegetal greases like soybean oil, rapeseed oil and corn oil, animal greases like butterfat and the processed greases obtained therefrom, as well as the greases for healthy consideration like diglycerides, greases containing mid-chain fatty acid and greases containing higher oleic acid, etc. Moreover, a suitable emulsifier may also be added for certain purposes like stabilizing the greases in the emulsification form and inhibiting generation of bubbles in the manufacturing process of the food or drink.

The species of the vitamins are either not particularly limited. The examples include various vitamins like ascorbic acid, riboflavin, pantothenic acid, folic acid and the vitamin B group, etc. Moreover, polysaccharides may be added suitably to improve the eating feel and to supply food fibers.

This invention is characterized in that a stable food or drink can be obtained even without a stabilizer, but does not exclude the use of a stabilizer.

The forms of the present food, including acidic drinks formed by adding to acidulant; acidic thick fluid foods, such as food and swallowing food, which contain protein as nitrogen source; acidic liquid nutrients; acidic soybean milk drinks; fermented soybean milk; acidic soybean protein drinks; acidic jelly drinks and gel food containing protein; acidic hemi-solid food like flower paste form a paste; acidic emulsions containing greases like creams and; granul like powdered drinks. Furthermore, the above jelly drinks and gel foods are not limited to gelatinize with a gelatinizer; and may be gelatinized proteins themselves emulsified gels containing greases. Moreover, the present food drink can be used as nursing foods, such as nutrition supplementary food, nutrition assistant food, food replacement and swallowing food, since they are enhanced in minerals.

The preparation process of the present food or drink varies with the form of the same and is not particularly limited in addition to using an acid-soluble soybean protein, possibly being a conventional process well known in the prior art. There is either no limitation on the supply form of the acid-soluble soybean protein, which can be for example a solution or a powder, while a powder generally can be dissolved sufficiently with a homomixer or the like. In addition to the acid-soluble soybean protein and metal salts, when acidic gustatory materials, sugars, greases, various vitamins, flavors, food fibers, polysaccharides and colorants are to be dissolved homogeneously in a solvent as required, the addition order thereof is not particularly limited. Generally, in a case using soybean protein isolate, it is needed to use an aforementioned high-pressure homogenizer or a super-high-pressure homogenizer in the prior art. However, the production of the present food or drink does not need such a homogenizer, but only needs equipment allowing sufficient dissolution to occur, thus providing a great merit in the production.

Furthermore, in a general case where the acidic food or drink contains soybean protein isolate, heating would facilitate the protein aggregation, so that certain attention is required. On the contrary, the stability of a solution containing acid-soluble soybean protein and minerals may be increased due to heating. Therefore, there is little limitation on the heating condition, which is another merit of this invention. It is enough to heat at 70° C. or higher for 5 minutes or longer. Generally, the heat-sterilization procedure which is necessary for the production of food or drink can also enhance the stability. The heat-sterilization can be one commonly used, but a sterilization system with high temperature in short time is preferred in view of the control of taste and microorganisms, wherein direct beat-sterilization by infusion, injection or the like is preferred.

The assay methods used in this invention are described as follows.

For the dissolution percentage of a protein, a 1 wt % aqueous solution of the sample was adjusted to the pH value for measurement, and the Kjeldahl method was used to determine the full protein amount in the aqueous solution and the protein amount in the supernatant after centrifugation under 8,000 G for 5 minutes. The dissolution percentage is calculated as the ratio of the protein amount in the supernatant to the full protein amount in the aqueous solution.

For the sourness of a food or drink, the sample is titrated with a 0.1M solution of sodium hydroxide until the pH value was 7.0, and the sourness was calculated as a citric acid equivalent. The calculation formula is “sourness (%)=the titration amount (mL) of 0.1M NaOH_{(aq)}×titer of 0.1M NaOH_{(aq)}×100/weight of sample (g)×0.0064”. The term “0.0064” in the formula refers to the weight (g) of anhydrous citric acid that corresponds to 1 mL of 0.1M NaOH_{(aq)}.

### EXAMPLES

The embodiments of this invention will be described in details with the following examples. However, the technical scope of this invention is not limited by the examples. Moreover, the exemplary contents of various minerals in the food or drink are not measured values, but are values calculated from the addition amounts of the mineral sources, unless otherwise specified. Also, the raw materials of the same name in different examples are the same product, unless otherwise specified.

### Production Example 1 of Acid-Soluble Soybean Protein

In this example, 35 kg of water was added into 5 kg of lowly denaturalized defatted soybean (Nitrogen soluble index (NSI)=91) obtained by planishing soybean and removing the oil with n-hexane as an extraction solvent. The mixture was adjusted to a pH value of 7 with diluted sodium hydroxide solution, stirred for 1 hour at room temperature for extraction and then centrifuged under 4,000 G to separate/remove the soybean curd residues and the insoluble part to obtain a defatted soybean milk. The defatted soybean milk was adjusted to a pH value of 4.5 with phosphoric acid, and then centrifuged under 2,000 G with a continuous centrifuge (a decanter) to obtain an insoluble fraction (acid-precipitated curd) and a soluble fraction (whey). To the acid-precipitated curd was added water to make a solid content of 10 wt %, resulting in a slurry of the acid-precipitated curd. The slurry was adjusted to a pH value of 4.0 with phosphoric acid and then heated to 40° C. To the solution was added phytase (produced by NOVO Co.) in an amount of 8 equivalents of the solid content, and the enzymatic action was performed for 30 minutes, wherein the resulting amount of phytic acid was 0.04 wt % of the solid content and no substantial change in the TCA solubility occurs. After the reaction, the solution was adjusted to a pH value of 3.5, heated for 15 seconds at 120° C. with a continuous direct heat-sterilization apparatus, and then spray-dried to produce 1.5 kg of an acid-soluble soybean protein powder. The dissolution percentage of this protein was 95% at a pH value of 4.3.

### Production Example 2 of Acid-Soluble Soybean Protein

A soybean milk with a solid content of 9% and a protein content of 4.5% was adjusted to a pH value of 3.5 with phosphoric acid and then heated to 40° C. To this solution, which has a phytic acid amount of 2.1 wt % of the solid content and a TCA solubility of 8.8%, was added with the phytase mentioned in Production Example 1 in an amount of 8 equivalents of the solid content, and the enzymatic reaction was performed for 30 minutes. After the reaction, the enzymatic reaction product having a phytic acid amount of 0.04 wt % of the solid content and a TCA solubility of 9.0% was heated for 15 seconds at 120° C. with a continuous direct heat-sterilization apparatus to produce an acid-soluble soybean protein in the form of soybean milk. The dissolution percentage of this protein was 92% at a pH value of 4.0.

### Comparative Example 1

An acidic protein drink is prepared, containing commercially available soybean protein isolate and calcium but no stabilizer.

At first, 4 weight parts of a commercially available soybean protein isolate “FujiPro CLE” from FujiOil Co., Ltd. and 10 weight parts of fructose were pre-dissolved in 80 weight parts of water with a high-speed emulsification disperser “TK homomixer” made by PRIMIX Corporation in 4000 rpm for 5 minutes. It is noted that the dissolution percentage of the soybean protein isolate is 32% at a pH value of 3.5. Next, 0.8 weight part of concentrated grapefruit juice and 0.5 weight part of calcium carbonate were added, and the mixture was adjusted to a pH value of 3.5 with citric acid, added with water to have 100 weight parts and then stirred with the TK homomixer in 4000 rpm for 5 minutes) for dissolution. The product is kept at 90° C. for 15 minutes for sterilization and then filled into a bottle container to produce a calcium-containing acidic protein drink that has a pH value of 3.5 and a calcium content of 200 mg/100 g.

The just prepared drink sample was in the form of dispersion, but aggregation was observed next day and the aggregation became so much after 3 days that the drink had no commercial value. Moreover, even if the drink is drunk after the aggregates were re-dispersed, the swallow feel was very bad and quite harsh. Furthermore, the drink was too sour to be attractive.

### Comparative Example 2

In Comparative Example 2, a stabilizer was used and a homogenizing treatment using a high-pressure homogenizer was performed. The preparation process was the same as in Comparative Example 1, except for the use of the stabilizer.

At first, 4 weight parts of the commercially available soybean protein isolate described in Comparative Example 1, 10 weight parts of fructose, 0.5 weight part of calcium carbonate, 0.5 weight part of pectin as a stabilizer and 0.5 weight part of the water-soluble soybean polysaccharide “SoyaFive S” from FujiOil Co., Ltd. were pre-dissolved in 80 weight parts of water with a high-speed emulsification disperser Next, the solution was heated to 80° C. while being stirred, added with 0.8 weight part of concentrated grapefruit juice, adjusted to a pH value of 3.5 with citric acid, and then added with water to have 100 weight parts. The solution was homogenized with a high-pressure homogenizer under 20 MPa, kept at 90° C. for 15 minutes for sterilization and then filled into a bottle container to produce a calcium-containing acidic protein drink that has a pH value of 3.5 and a calcium content of 200 mg/100 g.

The drink was in the form of dispersion as freshly prepared, but precipitation was observed after one week of conservation at 40° C. and the precipitation is so much after 2 weeks that the drink had no commercial value. The swallow feel was improved as compared with Comparative Example 1 due to the physical treatment with a high-pressure homogenizer and the addition of a stabilizer, but the improvement was still inadequate. Moreover, the taste is highly not refreshing due to the addition of pectin.

### Comparative Example 3

Except that 1.0 weight part of the water-soluble calcium lactate from Oriental Pharmaceutical Co., Ltd. was added instead of the calcium carbonate in Comparative Example 2, the same process of Comparative Example 2 was performed to produce a drink. The resulting drink has a pH value of 3.5 and a calcium content of 183 mg/100 g, and the solid part separated directly after the sterilization was re-dispersed by shaking. The swallow feel was still harsh although the physical treatment using a high-pressure homogenizer had been performed. Moreover, the taste is highly not refreshing due to the addition of pectin. Furthermore, aggregation was observed after 3 days of conservation at 40° C., and the precipitation is so much after several days that the drink had no commercial value.

### Example 1

Except for using 4 weight parts of the acid-soluble soybean protein powder from Production Example 1, a drink was prepared as in Comparative Examples 1-3. After 4 weeks of conservation at 40° C., no aggregation or precipitation was observed in the drink, which means good transparency and over-time stability for the drink. Moreover, the drink had a suitable sourness and a good swallow feel, thus being more attractive.

### Example 2

In this example, 40 weight parts of the acid-soluble soybean protein in the form of soybean milk from Production Example 2, 10 weight parts of fructose, 1 weight part of calcium lactate, 0.3 weight part of pectin, 0.5 weight part of water-soluble soybean polysaccharides and 20 weight parts of water were pre-dissolved with a high-speed emulsification disperser. Next, the solution was heated to 80° C. while being stirred, added with 0.8 weight part of concentrated grapefruit juice, adjusted to a pH value of 3.5 with citric acid and then added with water to have 100 weight parts. The solution was homogenized with a high-pressure homogenizer under 20 MPa, kept at 90° C. for 15 minutes for sterilization and then filled into a bottle container to produce a calcium-containing acidic protein drink, which has a pH value of 3.5 and a calcium content of 200 mg/100 g.

No aggregation was observed in this drink before the homogenization, and there was completely no precipitation even after 4 weeks of conservation at 40° C., which means good over-time stability for the drink. Moreover, the drink had a suitable sourness and a good swallow feel, thus being more attractive.

### Example 3

In this example, 4 weight parts of the acid-soluble soybean protein powder from Production Example 1, 10 weight parts of fructose, 0.5 weight part of calcium carbonate, 0.3 weight part of pectin as a stabilizer and 0.5 weight part of water-soluble soybean polysaccharides were pre-dissolved in 80 weight parts of water with a high-speed emulsification disperser. Next, the solution was heated to 80° C. while being stirred, added with 0.8 weight part of concentrated juice of mixed fruits, adjusted to a pH value of 5.0 with citric acid and then added with water to have 100 weight parts. The solution was homogenized with a high-pressure homogenizer under 20 MPa, kept at 90° C. for 15 minutes for sterilization and then filled into a bottle container to produce a calcium-containing acidic protein drink, which has a pH value of 5.0 and a calcium content of 200 mg/100 g.

The present drink is cloudy, but there was completely no aggregation and the dispersion was stable. Moreover, although there was a little precipitation in the drink after 4 weeks of conservation at 40° C., the amount of the precipitation was inadequate to eliminate the commercial value and the drink remained sufficiently stable. Furthermore, the drink had a good swallow feel and was therefore more attractive.

### Example 4

### Study on Addition Amount of Minerals

In this example, 40 weight parts of the acid-soluble soybean protein from Production Example 1 and 100 weight parts of fructose were pre-dissolved in 800 weight parts of water with a high-speed emulsification disperser. To 94 weight parts of this solution, a predetermined amount of the calcium gluconate from FUSO Chemical Co. Ltd. was added and dissolved with the high-speed emulsification disperser in 4000 rpm for 5 minutes, and then the solution was added with water to have 100 weight parts.

In this example, 4 different test samples were prepared with 4 different predetermined amounts of calcium gluconate, 0.7 weight part, 1 weight part, 2 weight parts and 3 weight parts, respectively for Samples 1-4. Each test sample was heated to 95° C. for sterilization and then filled into a can container to produce a calcium-containing acidic protein drink. The calcium contents in Samples 1-4 were 62 mg, 89 mg, 178 mg and 267 mg, respectively, per 100 g of drink.

Each test sample was conserved in a refrigerator and then evaluated sensuously by 10 panelists, wherein some bitterness from calcium was tasted in Sample 4, but any one of Samples 1-4 had a suitable sourness and was good at the swallow feel and the taste. Moreover, there was no harsh taste, aggregation or precipitation produced.

### Example 5

### Study on the Species of Minerals

In this example, 40 weight parts of the acid-soluble soybean protein from Production Example 1 and 100 weight parts of fructose were pre-dissolved in 800 weight parts of water with a high-speed emulsification disperser. Each of various mineral salts is individually added into 94 weight parts of the above solution in a certain amount and dissolved with the high-speed emulsification disperser in 4000 rpm for 5 minutes, and then the solution was added with water to have 100 weight parts. The solutions with different minerals were heated to 95° C. for sterilization and respectively filled into bottle containers to produce mineral-containing acidic protein drinks.

The minerals added were fermented calcium lactate from Purac Japan Corporation, calcium lactate from Oriental Pharmaceutical Co., Ltd., calcium carbonate as the super-high-purity calcium carbonate “3N-A” from Ube Material Industries, Ltd., iron lactate and iron pyrophosphate, respectively for Samples 1-5.

Any one of Samples 1-3 was prepared with 134 mg of calcium per 100 g of drink and each of Samples 4 and 5 was prepared with 2 mg of iron per 100 g of drink.

Each drink was then finely adjusted to a pH value of 3.5 with lactic acid and kept at 40° C. for 4 weeks. As a result, some precipitation considered as calcium carbonate is observed in Sample 3, but there was no precipitation in the other samples. Furthermore, each drink was evaluated sensuously and considered to have a suitable sourness, a good swallow feel and a good taste.

### Experimental Example

### Determination of Sourness

The commercially available soybean protein isolate “FujiPro F” from FujiOil, Co. Ltd. or the acid-soluble soybean protein from Production Example 1 was dispersed in water in a concentration of 5% and adjusted to a pH value of 3.5 with citric acid. The sourness of each solution was determined by the same method, and the sourness of the solution of the commercially available soybean protein isolate was determined as 0.97% while that of the solution of the acid-soluble soybean protein as 0.50%. There was a strong acidic stimulation for the solution of the commercially available soybean protein isolate so that the solution tastes bad, whereas the acidic stimulation for the solution of the acid-soluble soybean protein solution was reduced remarkably.

### Example 6

### Jelly Drink

To water were added 4.25 weight parts of the acid-soluble soybean protein from Production Example 1, 0.03 weight part of the Stevia preparation “Rebaudio ACK250” from Morita Kagaku Kogyo Co., Ltd., 0.2 weight part of the β-cyclodextrin “Cerdex B-100” from Nihon Shokuhin Kako Co., Ltd., 2 weight parts of trehalose, 4.5 weight parts of erythritol, 2 weight parts of cloudy concentrated white grapefruit juice and 0.25 weight part of a grapefruit flavor, which are dissolved with a high-speed emulsification disperser. This solution was added with 0.8 weight part of calcium gluconate, added with water to have 79.2 weight parts in total and then stirred in 4000 rpm for 5 minutes for dissolution, thus obtaining Solution 1. Moreover, Solution 2 was prepared by heating and dissolving 0.7 weight part of Japanese gelatin in a mixture of 9 weight parts of fructose-glucose liquid sugar, 20 weight parts of water and 0.1 weight part of sodium citrate, and was then mixed with Solution 1.

The resulting solution was subjected to heat-sterilization at 85° C. for 15 minutes, hot-filled into a standing pouch and then cooled with water flow to produce a jelly drink having a pH value of 3.8.

The jelly drink is a mineral-enhanced jelly drink containing 71.2 mg of calcium that has a good swallow feel, a suitable sourness and a good taste.

### Example 7

### Jelly (1)

To water were added 3 weight parts of the acid-soluble soybean protein from Production Example 1, 0.02 weight part of a Stevia preparation, 0.2 weight part of β-cyclodextrin, 20 weight parts of fructose, 1.5 weight parts of calcium gluconate and 0.8 weight part of pomelo flavor, which were dissolved with a high-speed emulsification disperser. This solution was added with 1.5 weight parts of calcium gluconate, added with water to have 89.4 weight parts and then stirred in 4000 rpm for 5 minutes for dissolution to produce Solution 1.

Moreover, Solution 2 was prepared by heat-dissolving 0.6 weight part of Japanese gelatin from Ina Food Industry Co., Ltd. in 10 weight parts of water, mixed with Solution 1, filled into a jelly cup and then sealed up. Thereafter, the solution was subjected to heat-sterilization in a water bath at 85° C. for 20 minutes and then cooled with water flow to produce a mineral-enhanced jelly having a pH value of 3.25.

The mineral-enhanced jelly contained 133.5 mg of calcium, and had a good swallow feel, a suitable sourness and a good taste.

### Example 8

### Jelly (2)

In this example, 14 weight parts of the acid-soluble soybean protein from Production Example 1, 0.01 weight part of sucralose from San-Ei Gen F.F.I., Inc., 4.0 weight parts of the calcium gluconate preparation “Gluconal CAL” from Purac Japan Corporation, 81.99 weight parts of 100%-reduced concentrated orange juice were mixed homogenously with a food cutter. After being debubbled, the paste was filled into a jelly cup and sealed up. Thereafter, the paste was subjected to heat-sterilization in a water bath at 80° C. for 1 hour and gelatinized simultaneously, so as to obtain a mineral-enhanced high protein jelly having a pH value of 4.0 that utilizes the gelatinization property of acid-soluble soybean protein.

The resulting mineral-enhanced high protein jelly contained 200 mg of calcium and 13 g of soybean protein per 100 g, thus allowing high mineral intake and high protein intake. The jelly also had a good taste and a better eating feel.

### Example 9

### Nursing Food and Swallowing Food (1)

In this example, 4.25 weight parts of the acid-soluble soybean protein from Production Example 1, 3.8 weight parts of palm oil, 0.03 weight part of a Stevia preparation, 0.2 weight part of β-cyclodextrin, 2 weight parts of trehalose, 4.5 weight parts of erythritol, 0.8 weight part of soybean polysaccharides were dispersed and dissolved in 48.482 weight parts of water. The pre-dissolution was performed with a high-speed emulsification disperser in 4000 rpm for 5 minutes.

Next this solution were added with 1.5 weight parts of calcium gluconate, 0.6 weight part of magnesium chloride, 0.018 weight part of iron (III) pyrophosphate, 0.5 weight part of the vitamin enhancer “Vitamin Mix-Multi” from BASF Takeda Vitamin Co., Ltd., 2.0 weight parts of the non-digested dextrin “Pine Fiber” from Matsutani Chemical Industry Co., Ltd. and 2 weight parts of cloudy concentrated white grapefruit juice, stirred for 5 minutes also with the high-speed emulsification disperser and then added with 0.25 weight part of a grapefruit flavor to produce Solution 1.

Moreover, Solution 2 was prepared by heat-dissolving 0.7 weight part of Japanese gelatin in a mixture of 9 weight parts of fructose-glucose liquid sugar, 20 weight parts of water and 0.1 weight part of sodium citrate, and was then mixed with Solution 1. The resulting mixture was subjected to heat-sterilization at 85° C. for 15 minutes, hot-filled into a standing pouch and then cooled with water flow to produce a jelly drink having a pH value of 3.52.

The jelly drink is a nutrition-enhanced jelly drink containing all nutrients necessary for the body, i.e., protein, lipid, saccharide, mineral, vitamin and food fiber, and is in the form of a soft gel glutinous to the mouth with little eating feel, so that it will not choke the elders and weaklings who have difficulty in swallowing. Besides, the jelly drink had a suitable sourness and a good taste.

### Example 10

### Nursing Food and Swallowing Food (2)

In this example, 4.3 weight parts of the acid-soluble soybean protein from Production Example 1, 12.5 weight parts of granular sugar, 1.25 weight parts of the fermented lactic acid dolomite from Meiji Diaries Corporation, 0.125 weight part of a vitamin enhancer, 0.1 weight part of tartaric acid, 0.1 weight part of a mineral yeast preparation “Mixed Mineral Yeast C”, 0.025 weight part of “Mixed Mineral Yeast M” from L-S Corporation and 0.06 weight part of a Stevia preparation were dry-mixed and then dispersed and dissolved in 46.04 weight parts of water. The dissolution was performed with a high-speed emulsification disperser. Then, 4.3 weight parts of cured rapeseed oil was added dropwise, and was stirred in a manner such that no oil part is separated to obtain Solution 1.

Moreover, 1.3 weight parts of a Japanese gelatin preparation “Agar Mix #24” from AOBA Kasei was dispersed in 25 weight parts of water and dissolved by heating the solution in a water bath for 10 minutes, so as to obtain Solution 2. Solution 2 was then mixed into Solution 1 while solution 1 was stirred, and the resulting solution was added with 4.0 weight parts of clear concentrated mango juice, 0.1 weight part of the pigment “β-carotene 10C” from Mitsubishi-Kagaku Foods Corporation and 0.9 weight part of a flavor and then filled into a standing pouch after mixing. Thereafter, the solution was subjected to heat-sterilization at 85° C. for 30 minutes and then cooled with water flow to produce a jelly drink having a pH value of 3.90.

The jelly drink contained protein, lipid and saccharide as the three main nutrients and provides a calorie of 1.2 kcal per gram, and was also a nutrition-enhanced jelly drink that fully contained other nutrients necessary for the body, i.e. calcium, magnesium, microelement minerals, vitamin and food fiber. The jelly drink will not choke the elders and weaklings who have difficulty in swallowing, since it is a soft jelly with a soft and smooth eating feel, a sticky feel in the throat and little dehydration. Moreover, the jelly drink can promote the secretion of saliva during the eating and increase the appetite due to its suitable sourness and good taste.

### Example 11

Nursing Food and High-Nutrition Frozen Dessert for Weaklings

In this example, 4.25 weight parts of the acid-soluble soybean protein from Production Example 1, 0.03 weight part of a Stevia preparation, 0.2 weight part of β-cyclodextrin, 2.0 weight parts of trehalose, 4.5 weight parts of erythritol and 0.8 weight part of soybean polysaccharides were dry-mixed, and was then poured into a mixture of 10.0 weight parts of coconut oil and 62.252 weight parts of water that had been pre-heated to 60° C. for dissolution. The pre-dissolution was performed with a high-speed emulsification disperser in 4000 rpm for 5 minutes.

Next, the solution was added 9.0 weight parts of fructose-glucose liquid sugar, 0.1 weight part of sodium citrate, 1.5 weight parts of calcium gluconate, 0.6 weight part of magnesium chloride, 0.018 weight part of iron (III) pyrophosphate, 0.5 weight part of a vitamin enhancer, 2.0 weight parts of a non-digested dextrin and 2.0 weight parts of cloudy concentrated white grapefruit juice, stirred for 5 minutes also with the high-speed emulsification disperser and then added with 0.25 weight part of grapefruit flavor to produce Solution 1.

Thereafter, Solution 1 was heated to 70° C. and stirred for 15 minutes for dissolution, homogenized with a homogenizer under a pressure of 100 kg/cm² and then subjected to a heating treatment in a UHT plate sterilizer at 120° C. for 15 minutes. Thereafter, the sterilized mixture was cooled to 5° C. and aged in a refrigerator for 20 hours to produce an ice cream mixture. One kilogram of the resulting mixture was frozen for 40 minutes by a commercially available freezer to produce a soft cream-like frozen dessert with high nutrition. Moreover, the cream was filled into a paper container and solidified overnight at −25° C. to produce an ice cream-like frozen dessert with high nutrition that has a pH value of 3.52.

The soft cream-like and ice-cream-like frozen desserts with high nutrition obtained as above were full nutrition-enhanced foods that contain all nutrients necessary for the body, i.e., protein, lipid, saccharide, mineral, vitamin and food fiber, and had a smooth eating feel and a refreshing feel of citrus tastes to be able to serve as desserts for the elders and weaklings.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. An acidic food or drink that contains acid-soluble soybean protein and minerals.

2. The acidic food or drink as claimed in claim 1, which has a pH value of 2-6.

3. The acidic food or drink as claimed in claim 1, wherein the minerals are water-soluble.
